(19) United States
(12) Patent Application Publication
(10) Pub. No.: US 2024/0394513 A1
(43) Pub. Date: Nov. 28, 2024

(54) LONG-TERM FORECASTING USING MULTI-LAYER PERCEPTRON NEURAL NETWORKS

(71) Applicant: Google LLC, Mountain View, CA (US)

(72) Inventors: Rajat Sen, San Francisco, CA (US); Shaan Karan Mathur, Fremont, CA (US); Abhimanyu Das, Los Altos, CA (US); Weihao Kong, San Jose, CA (US); Qi Yu, San Diego, CA (US); Andrew Bradford Leach, San Francisco, CA (US)

(21) Appl. No.: 18/671,875

(22) Filed: May 22, 2024

Related U.S. Application Data
(60) Provisional application No. 63/503,697, filed on May 22, 2023.

(51) Int. Cl. G06N 3/0455

(52) U.S. Cl. CPC G06N 3/0455

(57) ABSTRACT

Methods, systems, and apparatus, including computer programs encoded on computer storage media, for performing long-term forecasting using multi-layer perceptron neural networks. One of the methods includes obtaining time series data; and processing the time series data to generate a respective predicted time series value for each of a plurality of future time points in a horizon sequence, comprising: processing the time series data using an encoder multi-layer perceptron (MLP) neural network to generate an encoded representation of the time series data; and processing at least the encoded representation of the time series data using a decoder MLP neural network to generate a respective predicted time series value for each of the plurality of future time points.

### CROSS-REFERENCE TO RELATED APPLICATION

This application claims priority to U.S. Provisional Application No. 63/503,697, filed on May 22, 2023. The disclosure of the prior application is considered part of and is incorporated by reference in the disclosure of this application.

### BACKGROUND

This specification relates to making predictions for time series data.

For example, some systems make predictions for sequential inputs using machine learning models. In some of these examples, the machine learning models are trained using online learning.

### SUMMARY

This specification describes a system that generates future predictions from an input time series.

That is, the system receives an input that includes a time series up to the current time point and generates an output that is a prediction of the time series at future time points.

Particular embodiments of the subject matter described in this specification can be implemented so as to realize one or more of the following advantages.

Long-term forecasting, which the task of predicting several steps into the future given a long context or look-back, is one of the most fundamental problems in time series analysis, with broad applications to a variety of real-world tasks, e.g., energy and transportation.

Various neural network architectures have been explored for forecasting, ranging from recurrent neural networks to convolutional networks to graph neural networks. For example, some existing techniques attempt to apply Transformer-based architectures to long-horizon forecasting.

However, recent work has shown that, despite their modeling capacity, these Transformers-based architectures can be easily outperformed by a simple linear model on many forecasting tasks. Such a linear model however has deficiencies since that prevent it from reaching optimal performance. For example linear models are ill-suited for modeling non-linear dependencies among the time-series sequence and the time-independent covariates.

This specification describes a machine learning approach that addresses these issues by implementing an effective deep learning architecture for long-term forecasting that obtains superior performance when compared to existing state of the art neural network based models. In particular, the system uses a Multi-Layer Perceptron (MLP)-based model that does not use any self-attention, recurrent or convolutional mechanisms. Therefore, it enjoys a linear computational scaling in terms of the context and horizon lengths unlike, e.g., many Transformer-based solutions, while still achieving superior forecasting accuracy.

As a result, the described model achieves better or similar performance compared to prior neural network based baselines on many real-world forecasting datasets and, in fact, achieves >10% lower Mean Squared Error on the largest dataset relative to the highest-performing baseline.

At the same time, the described model is 5 times faster in terms of inference and more than 10 times faster in training when compared to the best Transformer based model, resulting in significantly reduced latency when making predictions and significantly reduced computational cost for both inference and training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example sequential prediction system.

FIG. 2 is a flow diagram of an example process for predicting future time series values at a given time point.

FIG. 3 is a flow diagram of an example process for processing the time series data using the encoder MLP.

FIG. 4 is a flow diagram of an example process for processing an input that includes the encoded representation using the decoder MLP.

FIG. 5 shows an example residual MLP block.

FIG. 6 shows an example of the operations performed by the system.

Like reference numbers and designations in the various drawings indicate like elements.

### DETAILED DESCRIPTION

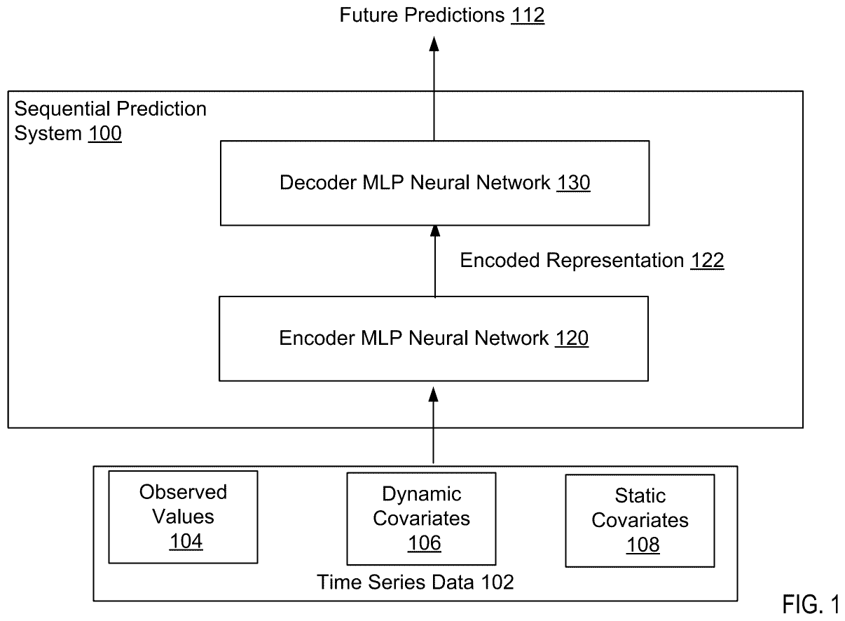

FIG. 1 shows an example sequential prediction system 100. The sequential prediction system 100 is an example of a system implemented as computer programs on one or more computers in one or more locations, in which the systems, components, and techniques described below can be implemented.

This system 100 generates future predictions 112 from an input time series.

In particular, in order to generate the future predictions 112, the system 100 obtains time series data 102.

The time series data includes (i) respective observed time series values 104 at each of a plurality of past time points in a look-back sequence and (ii) dynamic covariates data 106 that includes a respective set of dynamic covariates for each past time point and for each future time point of a plurality of future time points in a horizon sequence that follows the look-back sequence.

As one example, the time series can correspond to an entity, and the time series values can each be an observed value of a particular property of the entity at the corresponding time point.

Examples of entities and properties are described below.

The dynamic covariates are features that depend on the time point, i.e., that can be different for different time points. For example, dynamic covariates can include features characterizing the time of day, the date, or the day of the week corresponding to a given time point. As another example, dynamic covariates can include features characterizing environmental conditions, e.g., weather conditions, i.e., either actual or predicted environment conditions, depending on whether the time point is a past time point or a future time point. As another example, dynamic covariates can include features characterizing events occurring at the corresponding time point.

That is, when the prediction is being made as of time point L, the look-back sequence includes past time points 1 through L and the horizon sequence includes future time points L+1 through L+H, where H is a fixed number greater than one.

Thus, in this example the system 100 generates predictions for H future time points that are after the time point L.

The time series data 102 can also include one or more static covariates 108 that are static across all future and past time steps.

That is, static covariates 108 are features that do not change across time points. For example, when the time series values correspond to a given entity, the static covariates can be static features that characterize the entity that do not change with time, i.e., that represent static properties of the entity or of other relevant entities.

The system 100 processes the time series data 102 to generate the future predictions 112, i.e., to generate a respective predicted time series value for each of the plurality of future time points in the horizon sequence.

That is, the system 100 predicts time series values that are predicted continuations of the time series values at the past time points.

As one example, the time series can correspond to an entity, the observed time series values can each be an observed value of a particular property of the entity at the corresponding time point, and the predicted time series values can each be a predicted value of the particular property of the entity at the corresponding future time point.

In particular, the system 100 processes the time series data using an encoder multi-layer perceptron (MLP) neural network 120 to generate an encoded representation 122 of the time series data and then processes at least the encoded representation 122 of the time series data using a decoder MLP neural network 130 to generate the respective predicted time series value for each of the plurality of future time points in the horizon sequence.

Thus, the system 100 uses an encoder-decoder MLP-based model that, in some implementations, does not employ any recurrent operations, attention operations, or convolutional operations.

As a result, the system 100 can be particularly effective for long-term forecasting tasks, e.g., when the look-back sequence has a large number of time points, the horizon sequence has a large number of time points, or both.

The system 100 can be used to make predictions for any of a variety of time series data.

A few non-limiting examples now follow.

For example, the time series values can represent properties of electrical, mechanical, or electro-mechanical equipment. One example is when the time series values represent data collected from electricity transformers, e.g., load data or oil temperature or other state data, or other electrical equipment.

As another example, the time series values can represent electrical, water, gas, or other resource consumption of an entity, e.g., a household, a facility, or a company.

As another example, the time series values can represent properties of traffic on a roadway, e.g., road occupancy data.

As yet another example, the time series values can represent exchange rates between currencies.

As yet another example, the time series values can represent properties of a disease or other medical condition, e.g., the ratio of total patients seen that have the condition or other properties of the condition.

As yet another example, the time series values can represent properties of a product, service, or other entity that is available for users or customers, e.g., demand, price, and so on.

As yet another example, the time series values can represent properties of a computing resource, e.g., a hardware accelerator, a server, or another component of a data center, e.g., demand, workload, latency, and so on.

Additionally, this specification generally describes that the system 100 processes a single set of time series data 102. In practice, however, the time series data 102 can correspond to a single channel of a larger time series data set. That is, the system can receive a larger time series data set that includes multiple channels, one of which is represented by the time series data 102. Generally, each channel of the time series data 120 can include a respective set of observed values. For example, each channel can correspond to a different entity and can include observed values for the corresponding entity, i.e., each channel includes values of the same particular property, but for different entities. In these cases, the system can use the same encoder and decoder neural networks 120 and 130 to make the predictions for each channel independently. That is, the system 100 makes predictions for each channel independently using a single, shared machine learning model.

Prior to using the neural networks 120 and 130 to make predictions, the system 100 or another training system trains the neural networks on a set of training data. The training data generally includes multiple training examples, where each training example includes respective training time series data and respective ground truth time series values for each time step in a corresponding horizon sequence. The training system can use the training data to train the neural networks on a loss function, e.g., one that measures the mean squared error (MSE) between, for each training example, predicted time series values for the time steps in the horizon sequence generated using the training time series data in the training example and the corresponding ground truth time series values in the training example.

As a particular example, the training system can train the neural network using mini-batch gradient descent, where each batch consists of a batchSize number of time-series and the corresponding look-back and horizon time-points. In some cases, each epoch during the training can include all look-back and horizon pairs that can be constructed from the training period, i.e., two mini-batches can have overlapping time-points.

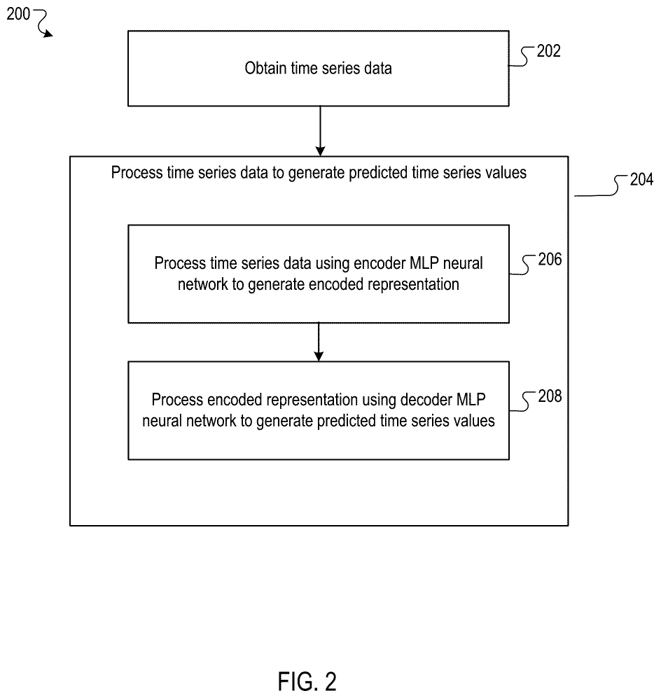

FIG. 2 is a flow diagram of an example process 200 for predicting future time series values at a given time point. For convenience, the process 200 will be described as being performed by a system of one or more computers located in one or more locations. For example, a sequential prediction system, e.g., the sequential prediction system 100 of FIG. 1, appropriately programmed, can perform the process 200.

Generally, the system performs the process 200 to generate a respective predicted time series value for each future time point in a horizon sequence, i.e., for each of multiple time points that are each after the given time point.

The system obtains time series data as of the given time point (step 202).

Generally, the time series data includes respective observed time series values at each of a plurality of past time points in a look-back sequence. That is, the look-back sequence includes respective observed time series values at each of multiple past time points that already occurred prior to the given time point.

The time series data also includes dynamic covariates data. The dynamic covariates data includes a respective set of dynamic covariates for each past time point and for each future time point of a plurality of future time points in the horizon sequence that follows the look-back sequence.

Optionally, the time series data can also include static covariates data that is constant throughout the past and future time points.

The system processes the time series data to generate a respective predicted time series value for each of the plurality of future time points in the horizon sequence (step 204).

As part of this processing, the system processing the time series data using an encoder multi-layer perceptron (MLP) neural network to generate an encoded representation of the time series data (step 206).

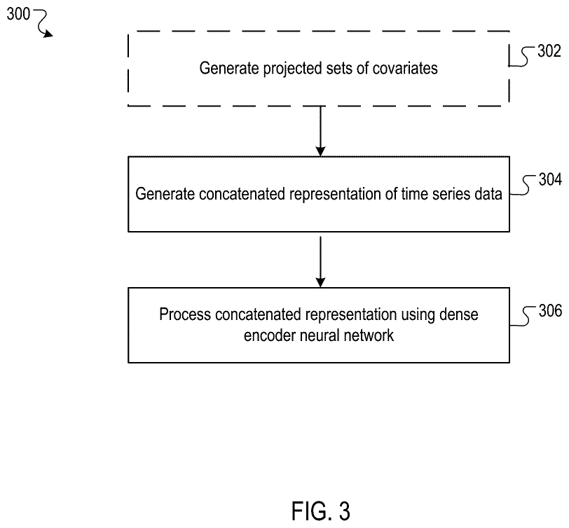

Processing the time series data using the encoder MLP is described in more detail below with reference to FIG. 3

The system also processes at least the encoded representation of the time series data using a decoder MLP neural network to generate the respective predicted time series value for each of the plurality of future time points in the horizon sequence (step 208).

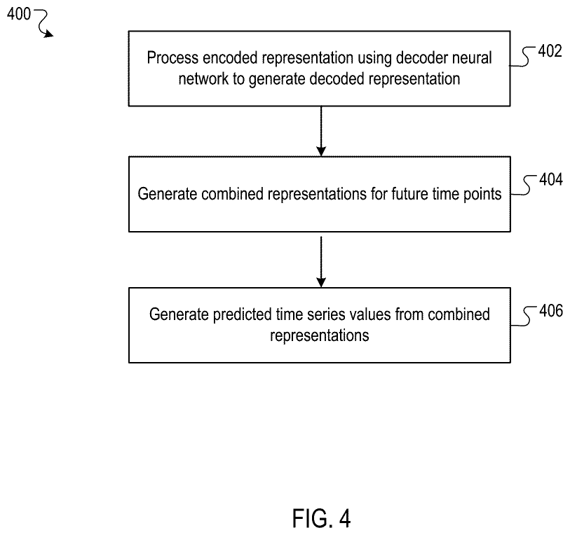

Processing an input that includes the encoded representation using the decoder MLP is described in more detail below with reference to FIG. 4.

FIG. 3 is a flow diagram of an example process 300 for processing the time series data using the encoder MLP. For convenience, the process 300 will be described as being performed by a system of one or more computers located in one or more locations. For example, a sequential prediction system, e.g., the sequential prediction system 100 of FIG. 1, appropriately programmed, can perform the process 300.

Optionally, for each past and future time point, the system can process the set of covariates for the time point using a feature projection MLP neural network to generate a projected set of covariates for the time point (step 302).

This operation can serve as a dimensionality reduction to reduce the dimensionality of the dynamic covariates prior to being consumed by the remainder of the neural network.

As one example, the feature projection MLP neural network can be a residual MLP block that has an input dimension that is larger than the output dimension.

Residual MLP blocks will be described in more detail below.

The system can concatenate at least the observed time series values for the past time points and (i) the respective sets of covariates for the observed time steps and the future time steps or (ii) if step 302 is performed, the respective projected sets of covariates for the observed time steps and the future time steps to generate a concatenated representation of the time series data (step 304).

When the time series data also includes the one or more static covariants that are static across the past and future time points, the system can also concatenate the one or more static covariants with the observed time series values and (i) or (ii) as part of generating the concatenated representation.

In particular, the system can stack and flatten all the past and future (projected) dynamic covariates, concatenate them with the static covariates and the past observed time series values to generate the concatenated representation.

The system processes the concatenated representation of the time series data using a dense encoder MLP neural network to generate the encoded representation (step 306).

As one example, the encoded representation can be a single embedding vector that represents the time series data.

Generally, the dense encoder MLP neural network can be a neural network that includes a sequence of residual MLP blocks, each with the same, fixed hidden dimension.

FIG. 4 is a flow diagram of an example process 400 for processing an input that includes the concatenated representation of the time series data using the decoder MLP. For convenience, the process 400 will be described as being performed by a system of one or more computers located in one or more locations. For example, a sequential prediction system, e.g., the sequential prediction system 100 of FIG. 1, appropriately programmed, can perform the process 400.

The system processes the encoded representation using a dense decoder MLP neural network to generate a decoded representation that includes a respective decoded vector for each future time point (step 402).

In particular, the dense decoder neural network can receive the encoded representation, e.g., as a single embedding, and map the encoded representation to a vector that has H×p values, where H is the number of future time points and d is the dimensionality of each decoded vector. The system can then reshape the output vector to generate the decoded vectors, e.g., by generating a matrix D that has d rows and H columns (or H rows and d columns).

As one example, the dense decoder neural network can be a sequence of MLP residual blocks.

The system then processes at least the decoded representations to generate the respective predicted time series value for each of the plurality of future time points in the horizon sequence.

As one example, for each future time point, the system can combine the decoded vector for the time point and (i) the respective set of covariates for the future time point or (ii) the respective projected set of covariates for the future time point to generate a combined representation for future time point (step 404).

For each future time point, the system can then generate the respective predicted future time series value for the future time point from the combined representation for the future time point (step 406).

For example, the system can process the combined representation for the future time point using a temporal decoder MLP neural network to generate an initial predicted time series value for the future time point.

For example, the temporal decoder MLP can be implemented as a residual MLP block. Using the combined representation instead of only the decoded vector to generate the initial prediction adds a “highway” from the future covariates at time-step L+t to the prediction at time-step L+t. This can be useful if some covariates have a strong direct effect on a particular time-step's actual value. For instance, in retail demand forecasting a holiday like Mother's day might strongly affect the sales of certain gift items. Such signals can be lost or take longer for the model to learn in absence of such a highway.

In some cases, the system uses the initial predicted time series value as the predicted time series value.

In some other cases, the system can also apply a linear mapping to the observed time series values to generate a respective linear predicted time series value for each future time point and generate a final predicted future time series value for the time point from the respective linear predicted time series value for the time point and the initial predicted time series value for the future time point. For example, for each future time point, the system can add the respective linear predicted time series value for the time point and the initial predicted time series value for the future time point to generate the predicted time series value. This ensures that a purely linear model is always a subclass of the neural network, i.e., allows the system to learn, during training, to default to linear predictions if appropriate.

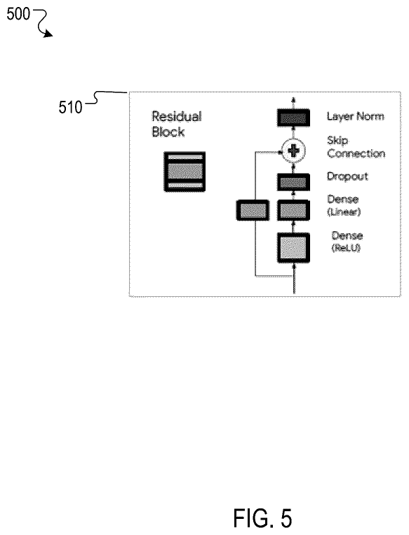

FIG. 5 shows an example 500 of a residual MLP block 510.

In general, a residual MLP block includes a MLP, a linear skip connection, and a combining layer to sum an output of the MLP and an output of the linear skip connection. Thus, the block is referred to as “residual” because the combining layer forms a residual connection between the input to the block and the output of the block.

Optionally, each residual block can include a layer norm operation that is applied to the sum of the output of the MLP and the output of the linear skip connection.

At least during training, each residual block can also include a dropout operation, e.g., after the MLP and before the skip connection.

Such a residual MLP layer block 510 is shown in FIG. 5.

As shown in FIG. 5, the residual MLP layer block 510 includes an MLP that operates on the block input includes a dense neural network layer followed by a ReLU non-linearity and then followed by another dense neural network layer.

The residual MLP layer block also includes a dropout operation after the MLP.

The block 510 also includes a linear layer that operates on the block input and a skip connection that sums the output of the linear layer and the MLP (optionally after dropout is applied). Additionally, the block 510 includes a Layer Norm operation that is applied to the output of the MLP.

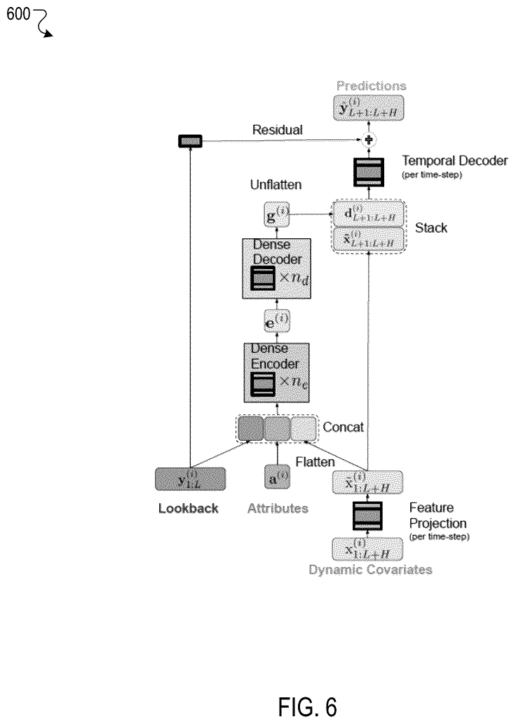

FIG. 6 shows an example 600 of the operation of the encoder and decoder neural networks.

As shown in FIG. 6, the time series input includes the lookback sequence, the static covariates (“attributes”), and the dynamic covariates and the system uses the encoder and decoder neural networks to predict time series values for each time step in the horizon sequence.

The encoder neural network, for each past and future time point, processes the set of covariates for the time point using a feature projection MLP neural network (“feature projection”) to generate a projected set of covariates for the time point.

The encoder neural network then concatenates (“concat”) the observed time series values for the past time points, the one or more static covariants, and the respective projected sets of covariates for the observed time steps and the future time steps to generate a concatenated representation of the time series data.

The encoder neural network then processes the concatenated representation of the time series data using a dense encoder MLP neural network to generate, as the output of the encoder, the encoded representation.

The decoder neural network then processes the encoded representation using a dense decoder MLP neural network to generate a decoded representation that includes a respective decoded vector for each future time point. In particular, the system “unflattens” the output of the last residual block within the decoder in order to generate the decoded vectors for the future time points.

For each future time point, the decoder neural network then combines (“stacks”) the decoded vector for the time point and (he respective projected set of covariates for the future time point to generate a combined representation for future time point.

The decoder neural network then processes the combined representation for the time point using a temporal decoder MLP neural network to generate an initial predicted time series value for the future time point.

The decoder neural network also applies a linear mapping to the observed time series values to generate a respective linear predicted time series value for each future time point and generates a final predicted future time series value for the time point from the respective linear predicted time series value for the time point and the initial predicted time series value for the future time point, i.e., by summing, for each future time point, the respective linear predicted time series value for the time point and the initial predicted time series value for the future time point.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining time series data, the time series data comprising (i) respective observed time series values at each of a plurality of past time points in a look-back sequence and (ii) dynamic covariates data that comprises a respective set of dynamic covariates for each past time point and for each future time point of a plurality of future time points in a horizon sequence that follows the look-back sequence; and
processing the time series data to generate a respective predicted time series value for each of the plurality of future time points in the horizon sequence, comprising:
processing the time series data using an encoder multi-layer perceptron (MLP) neural network to generate an encoded representation of the time series data; and
processing at least the encoded representation of the time series data using a decoder MLP neural network to generate the respective predicted time series value for each of the plurality of future time points in the horizon sequence.

2. The method of claim 1, wherein processing the time series data using an encoder multi-layer perceptron (MLP) neural network to generate an encoded representation of the time series data comprises:
for each past and future time point, processing the set of covariates for the time point using a feature projection MLP neural network to generate a projected set of covariates for the time point.

3. The method of claim 1, wherein processing the time series data using an encoder multi-layer perceptron (MLP) neural network to generate an encoded representation of the time series data comprises:
concatenating at least the observed time series values for the past time points and (i) the respective sets of covariates for the observed time steps and the future time steps or (ii) respective projected sets of covariates for the observed time steps and the future time steps to generate a concatenated representation of the time series data; and
processing the concatenated representation of the time series data using a dense encoder MLP neural network to generate the encoded representation.

4. The method of claim 3, wherein the time series data comprises one or more static covariants that are static across the past and future time points, and wherein the concatenating comprises:
concatenating the observed time series values for the past time points, the one or more static covariants, and (i) the respective sets of covariates for the observed time steps and the future time steps or (ii) the respective projected sets of covariates for the observed time steps and the future time steps to generate a concatenated representation of the time series data.

5. The method of claim 1, wherein processing at least the encoded representation of the time series data using a decoder MLP neural network to generate the respective predicted time series value for each of the plurality of future time points in the horizon sequence comprises:
processing the encoded representation using a dense decoder MLP neural network to generate a decoded representation that comprises a respective decoded vector for each future time point; and
processing at least the decoded representation to generate the respective predicted time series value for each of the plurality of future time points in the horizon sequence.

6. The method of claim 5, wherein processing at least the decoded representation to generate the respective predicted time series value for each of the plurality of future time points in the horizon sequence comprises, for each future time point:
combining the decoded vector for the time point and (i) the respective set of covariates for the future time point or (ii) a respective projected set of covariates for the future time point to generate a combined representation for future time point; and
generating the respective predicted future time series value for the future time point from the combined representation for the future time point.

7. The method of claim 6, wherein generating the respective predicted future time series value for the future time point from the combined representation for the future time point comprises:
processing the combined representation for the time point using a temporal decoder MLP neural network to generate an initial predicted time series value for the future time point.

8. The method of claim 7, wherein generating the respective future time series value for the future time point from the combined representation for the future time point further comprises:
applying a linear mapping to the observed time series values to generate a respective linear predicted time series value for each future time point; and
generating a final predicted future time series value for the time point from the respective linear predicted time series value for the time point and the initial predicted time series value for the future time point.

9. The method of claim 1, wherein the encoder MLP neural network and the decoder MLP neural network do not any include any convolutional, recurrent, or attention operations.

10. The method of claim 1, wherein the encoder MLP neural network and the decoder MLP neural network each include one or more respective residual blocks, and wherein each residual block includes:
an MLP;
a linear skip connection; a
a combining layer to sum an output of the MLP and an output of the linear skip connection.

11. The method of claim 10, wherein each residual block includes a layer norm operation that is applied to the sum of the output of the MLP and the output of the linear skip connection.

12. The method of claim 1, wherein the encoded representation is a single embedding vector that represents the time series data.

13. The method of claim 1, wherein the time series data corresponds to a single channel of a larger time series data set.

14. A system comprising one or more computers and one or more storage devices storing instructions that when executed by the one or more computers cause the one or more computers to perform operations comprising:
obtaining time series data, the time series data comprising (i) respective observed time series values at each of a plurality of past time points in a look-back sequence and (ii) dynamic covariates data that comprises a respective set of dynamic covariates for each past time point and for each future time point of a plurality of future time points in a horizon sequence that follows the look-back sequence; and
processing the time series data to generate a respective predicted time series value for each of the plurality of future time points in the horizon sequence, comprising:
processing the time series data using an encoder multi-layer perceptron (MLP) neural network to generate an encoded representation of the time series data; and
processing at least the encoded representation of the time series data using a decoder MLP neural network to generate the respective predicted time series value for each of the plurality of future time points in the horizon sequence.

15. The system of claim 14, wherein processing the time series data using an encoder multi-layer perceptron (MLP) neural network to generate an encoded representation of the time series data comprises:
for each past and future time point, processing the set of covariates for the time point using a feature projection MLP neural network to generate a projected set of covariates for the time point.

16. The system of claim 14, wherein processing the time series data using an encoder multi-layer perceptron (MLP) neural network to generate an encoded representation of the time series data comprises:
concatenating at least the observed time series values for the past time points and (i) the respective sets of covariates for the observed time steps and the future time steps or (ii) respective projected sets of covariates for the observed time steps and the future time steps to generate a concatenated representation of the time series data; and
processing the concatenated representation of the time series data using a dense encoder MLP neural network to generate the encoded representation.

17. The system of claim 16, wherein the time series data comprises one or more static covariants that are static across the past and future time points, and wherein the concatenating comprises:
concatenating the observed time series values for the past time points, the one or more static covariants, and (i) the respective sets of covariates for the observed time steps and the future time steps or (ii) the respective projected sets of covariates for the observed time steps and the future time steps to generate a concatenated representation of the time series data.

18. The system of claim 14, wherein processing at least the encoded representation of the time series data using a decoder MLP neural network to generate the respective predicted time series value for each of the plurality of future time points in the horizon sequence comprises:
processing the encoded representation using a dense decoder MLP neural network to generate a decoded representation that comprises a respective decoded vector for each future time point; and
processing at least the decoded representation to generate the respective predicted time series value for each of the plurality of future time points in the horizon sequence.

19. The system of claim 18, wherein processing at least the decoded representation to generate the respective predicted time series value for each of the plurality of future time points in the horizon sequence comprises, for each future time point:
combining the decoded vector for the time point and (i) the respective set of covariates for the future time point or (ii) a respective projected set of covariates for the future time point to generate a combined representation for future time point; and
generating the respective predicted future time series value for the future time point from the combined representation for the future time point.

20. One or more non-transitory computer storage media storing instructions that when executed by one or more computers cause the one or more computers to perform operations comprising:
obtaining time series data, the time series data comprising (i) respective observed time series values at each of a plurality of past time points in a look-back sequence and (ii) dynamic covariates data that comprises a respective set of dynamic covariates for each past time point and for each future time point of a plurality of future time points in a horizon sequence that follows the look-back sequence; and
processing the time series data to generate a respective predicted time series value for each of the plurality of future time points in the horizon sequence, comprising:
processing the time series data using an encoder multi-layer perceptron (MLP) neural network to generate an encoded representation of the time series data; and
processing at least the encoded representation of the time series data using a decoder MLP neural network to generate the respective predicted time series value for each of the plurality of future time points in the horizon sequence.
